(19) United States
(12) Patent Application Publication
(10) Pub. No.: US 2010/0070266 A1
(43) Pub. Date: Mar. 18, 2010

(54) Performance metrics for telephone-intensive personnel

(75) Inventors: Iain J. McNeill, Aptos, CA (US); J. Stephen Graham, Scotts Valley, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: Plantronics, Inc., A DELAWARE CORPORATION, Santa Cruz, CA (US)

(21) Appl. No.: 10/672,472

(22) Filed: Sep. 26, 2003

(51) Int. Cl. G10L 19/00; H04M 3/22

(52) U.S. Cl. 704/201; 379/32.04; 704/E11.003

(57) ABSTRACT

Systems and methods for generating performance metrics to monitor and/or enhance the performance of telephone-intensive personnel are disclosed. The method generally includes detecting voice activity on a receive and/or a transmit channel in a communications system, outputting voicing decision outputs based on the detecting, storing the voicing decision outputs over a period of time to memory, and generating voice activity performance metrics based on the voicing decision output stored in the memory. The generating may include generating a running average ratio of duration of voice activity on the transmit channel to duration of voice activity on the receive channel (talk-listen ratio) over a certain period of time for one or more agents. The talk-listen ratio may be compared to a target ratio. The system may generally include a voice activity detector (VAD) configured to detect voice activity on a receive and/or transmit channel in a communications system, a memory to store outputs from the VAD, and a voice activity analyzer configured to generate performance metrics based on the VAD outputs stored in the memory.

### BACKGROUND OF THE INVENTION

1. Field of the Invention

The present invention relates generally to speech processing in communications systems. More specifically, systems and methods for generating performance metrics to monitor and/or enhance the performance of telephone-intensive personnel are disclosed.

2. Description of Related Art

Telephones and computer or other processor-based telephony applications are used extensively by telephone-intensive agents such as operators, customer service agents such as in call centers, and/or other telephone-intensive service personnel. Often, the telephone-intensive agents use headsets connected to telephone sets or to computers or other processor-based hosts adapted for computer telephony (generally referred to as softphones).

These telephone-intensive operations are often costly as each call must be separately handled by an agent and thus are very labor-intensive. Because of the costs associated with such telephone-related operations, productivity and efficiency are very important in trying to achieve cost effectiveness. Cost effectiveness depends on, for example, the average length of each call, the number of calls handled by each service professional per shift, and so forth. In addition to cost effectiveness, it is also important for such telephone-intensive operations to achieve high quality and effectiveness in order to build broader a customer base, generate good will, and/or sell more products and services, for example.

Traditional performance monitoring techniques have generally focused on the quantity of calls a particular agent or group of agents completes. These metrics time each call, monitor the amount of time a caller had to wait to have their call answered and/or the number of callers who gave up. However, these techniques do not offer insight into the quality of the calls.

Thus what are needed are systems and methods to monitor and track the calls in order to generate better metrics reflecting to the quality and performance of the telephone calls. Such metrics would ideally be utilized in improving and optimizing the quality of the services performed by such telephone-intensive service agents.

### SUMMARY OF THE INVENTION

Systems and methods for generating performance metrics to monitor and/or enhance the performance of telephone-intensive personnel are disclosed. It should be appreciated that the present invention can be implemented in numerous ways, including as a process, an apparatus, a system, a device, a method, or a computer readable medium such as a computer readable storage medium or a computer network wherein program instructions are sent over optical, wireless or electronic communication lines. Several inventive embodiments of the present invention are described below.

The method may generally include detecting voice activity on a receive and/or a transmit channel in a communications system, outputting voicing decision outputs based on the detecting, storing the voicing decision outputs over a period of time to memory, and generating voice activity performance metrics based on the voicing decision output stored in the memory. The generating may include generating a running average ratio of duration of voice activity on the transmit channel to duration of voice activity on the receive channel (talk-listen ratio) over a certain period of time for one or more agents. The talk-listen ratio may be compared to a target ratio.

According to another embodiment, the system may generally include a voice activity detector (VAD) configured to detect voice activity on a receive and/or transmit channel in a communications system, a memory to store outputs from the VAD, and a voice activity analyzer configured to generate performance metrics based on the VAD outputs stored in the memory.

These and other features and advantages of the present invention will be presented in more detail in the following detailed description and the accompanying figures which illustrate by way of example the principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 is a block diagram illustrating a communications system implementing a voice activity detect (VAD) system in both the transmit and receive directions.

FIG. 2 is a block diagram illustrating a voice activity processing system of the communications system in more detail.

FIG. 3 is a flowchart illustrating a voice activity analysis process performed by the voice activity processing system.

FIG. 4 is an example of a graph illustrating the ratio of time spent talking to time spent listening (talk-listen ratio) for each call to the number of calls in a given period of time.

FIG. 5 is an example of a graph illustrating the talk-listen ratio over the duration of a given call or averaged over several calls.

FIG. 6 is an example of a graph illustrating the average talk-listen ratio over time such as the duration of a work shift.

FIG. 7 is an example of a chart illustrating the cumulative talk time for each agent for the current shift.

FIG. 8 illustrates an example of a computer system that can be utilized with the various embodiments of method and processing described herein.

FIG. 9 illustrates a system block diagram of the computer system of FIG. 8.

### DESCRIPTION OF SPECIFIC EMBODIMENTS

Systems and methods for generating performance metrics to monitor and/or enhance the performance of telephone-intensive personnel are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

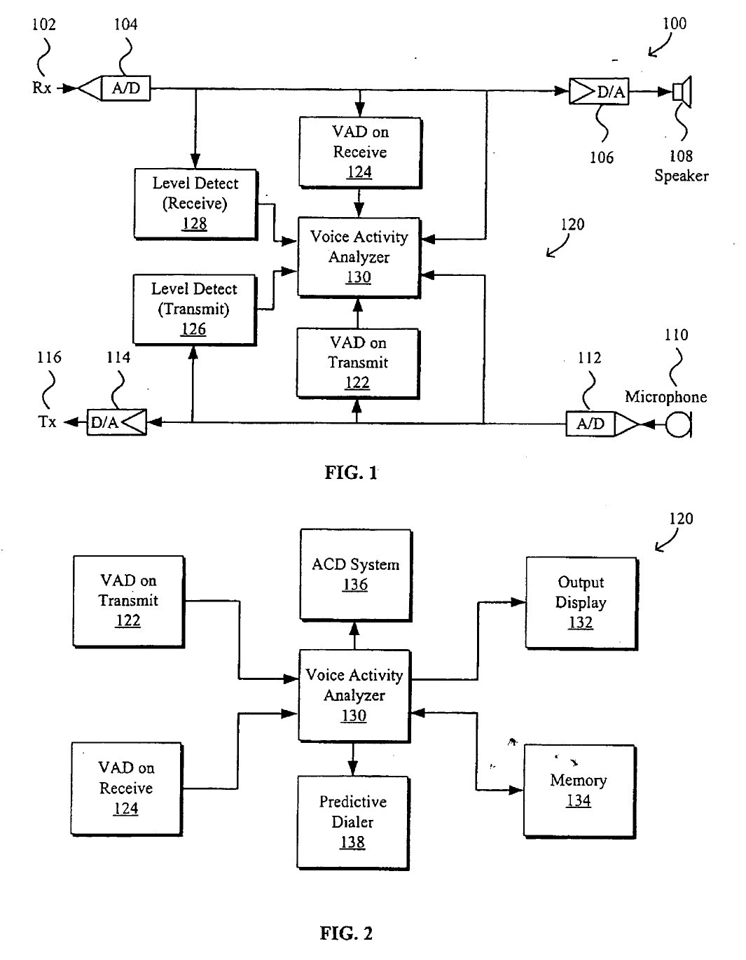

FIG. 1 is a block diagram illustrating a communications system 100 implementing a voice activity detect (VAD) system in both the transmit and receive directions. The communications system 100 may be implemented as a telephone or a processor-based host adapted for computer telephony having a headset or a handset, for example. As shown, the communications system 100 may include various optional analog to digital (A/D) and digital to analog (D/A) converters for converting analog signals to digital signals and for converting digital signals to analog signals, respectively. For the signal receiving data path, the system 100 converts received signals (Rx) 102 to digital signals with an A/D converter 104. After various digital signal processing (DSP), the received signals are converted back to analog signals using a D/A converter 106 and output on a speaker 108. For the signal transmission data path, analog signals received from a microphone 110 may be converted to digital signals using an A/D converter 112. The digital transmit signals are utilized for various DSP functions and converted back to analog signals using a D/A converter 114 and transmitted as transmit signals 116. The connections shown merely illustrate communication among the various components and may represent any communications mechanism, e.g., via optical, wireless or electronic communication lines.

Although the communications system 100 shown is a digital implementation, i.e., the entire receive and transmit data paths are DSP-based, it is to be understood that analog and/or digital-analog hybrid implementations may be employed. The digital implementation of the communications system 100 may be adopted for applications such as a wireless headset or handset using digital radios.

The communication system 100 may provide various digital speech processing in order to provide an efficient system. For example, the speech processing systems of the communication system 100 may include a voice activity processing system 120 that includes at least one voice activity detector (VAD), also referred to as a signal classifier. The VAD determines when the user is speaking and when the user is silent. The output of the VAD, also known as a voicing decision, may be binary in one implementation. The voicing decision may be used to control, for example, when to measure the level of background noise, when to suppress sending speech packets across a wireless medium (silence suppression), when to adapt a speech filter or speech beamformer to the user's speech, or when to adapt a noise filter or noise beamformer to the background noise. It is also noted that various other components of the communications system 100 are not shown for purposes of clarity.

The voice activity processing system 120 may include a VAD on transmit 122 and/or a VAD on receive 124 as well as a voice activity analyzer 130 for receiving and analyzing output from the VAD on transmit 122 and/or the VAD on receive 124. The VAD on transmit 122 and the VAD on receive 124 determine whether the user or the far-end listener, respectively, is speaking at any given point in time. As used herein, the “user” generally refers to the near-end person using the headset or handset while the “far-end listener” refers to the person at the other end of the telephone conversation. Preferably, the VAD is implemented with a relatively long time constant on the order of approximately 40 to 100 ms. Typically, the VAD is provided only on the transmit data path, i.e., the VAD on transmit 122. However, it is to be understood that the VAD on receive 124 may be additionally or alternatively provided. Where only the VAD on transmit 122 or the VAD on receive 124 is provided, the voice activity analyzer 130 may assume that if there is no voice activity on the channel or data path being monitored when a call is active, there is voice activity on the other channel or data path not being monitored. However, a more accurate measure of talk and listen times may be achieved when the VAD on transmit 122 and the VAD on receive 124 are separately implemented. It is noted that the VAD need not be separately provided but may be incorporated in other components of communication system 100 such as in an echo canceller, an automatic call distribution (ACD) system, and/or a predictive dialing system. An echo canceller typically can detect voice activity in the transmit direction, the receive direction, and/or in both directions, i.e., doubletalk.

The VAD on transmit 122 detects when a user is talking. Similarly, the VAD on receive 124 detects when the far-end listener is talking. The voice activity analyzer 130 measures and tracks the duration of these voice activities to generate various performance metrics. The voice activity analyzer 130 may be local to the communications system 100. For example, the voice activity analyzer 130 may be a microcontroller or a digital signal processor (DSP), for example, a headset adapter. Alternatively, the voice activity analyzer 130 may be remote to the communications system 100. For example, the communications system 100 may transmit the output signals from the VAD on transmit 122 and the VAD on receive 124 to the remote voice activity analyzer 130 in a processor-based host by signaling over a separate channel such as via a serial or parallel personal computer (PC) port, a universal serial bus (USB) connection, a local area network (LAN), a wireless channel, and so forth.

The voice activity analyzer 130 may also receive or otherwise generate data relating to the voice activity level, i.e., amplitude. The voice activity level may facilitate in determining the general progression of the conversation. For example, the voice activity level may facilitate in determining stress or strain in the agent's voice, whether either party to the conversation is raising his/her voice or shouting or whether the conversation is calm, and/or whether a question or statement is being spoken.

The voice activity analyzer 130 may receive data relating to the voice activity level from a voice level detector on transmit 126 and/or a voice level detector on receive 128. Alternatively, the VAD on transmit 122 and/or the VAD on receive 124 may detect, in addition to voice activity, voice activity levels on the transmit and receive channels. As yet another alternative, the voice activity analyzer 130 may receive and analyze signals from the transmit and receive channels to determine the voice activity level. The voice activity analyzer 130 may perform the voice activity level analysis on the signals from the transmit channel only when the VAD on transmit 122 has signaled to the voice activity analyzer 130 that there is voice activity on the transmit channel. Similarly, the voice activity analyzer 130 may perform the voice activity level analysis on the signals' from the receive channel only when the VAD on receive 124 has signaled to the voice activity analyzer 130 that there is voice activity on the receive channel. Alternatively, if the VAD on receive 124 is not provided, the voice activity analyzer 130 may perform the voice activity level analysis on the signals from the receive channel only when the VAD on transmit 122 has signaled to the voice activity analyzer 130 that there is no voice activity on the transmit channel. In this example, the voice activity analyzer 130 is preferably in relatively close proximity to and/or in direct communication with the receive and transmit channels to minimize delays in signal transmission and thus errors caused by such transmission delays.

The voice activity processing system 120 is shown in more detail in the block diagram of FIG. 2. As shown, the voice activity processing system 120 includes the VAD on transmit 122 and/or the VAD on receive 124, the voice activity analyzer 130, an output display 132, and a memory 134. The output display 132 may be an audio and/or video display. Examples of output displays 132 include an LCD provided locally by the communications system or a display such as a monitor provided remotely by a processor-based host such as a personal computer. The output display 132 may also be in the form of a hardcopy such as a paper printout. The memory 134 may be in communication with the voice activity analyzer 130 to store VAD output data and optionally various performance metrics generated by the voice activity analyzer 130. Alternatively or additionally, the memory 134 may be in direct communication with the VAD on transmit 122 and/or the VAD on receive 124.

The voice activity analyzer 130 may be in communication with an automatic call routing system such as an ACD system 136 and/or a predictive dialer system 138. As is known, ACD systems automatically route calls based on various data and are typically employed in customer service and/or technical support applications, for example. The predictive dialer system 138 automatically dials calls based on various data and is typically employed in telemarketing and/or customer survey applications, for example. It is noted that the ACD system 136 and/or the predictive dialer system 138 may include the VAD on transmit and/or the VAD on receive of the communications system and thus may transmit the VAD output to the voice activity analyzer 130. The voice activity analyzer 130 may in turn transmit various performance metrics to the ACD system 136 and/or the predictive dialer system 138 such that the ACD system 136 automatically routes incoming calls and/or the predictive dialer system 138 automatically dials outgoing calls based at least in part on the performance metrics and thus improve performance and productivity.

The voice activity processing system 120 preferably continuously or continually receives output signals from the VAD on transmit 122 and/or the VAD on receive 124 during active calls so as to monitor and track voice activity on the transmit and/or receive data paths. As noted above, if only one VAD is employed, i.e., the VAD on transmit 122 or the VAD on receive 124, the voice activity analyzer 130 may assume that there is voice activity on the other, non-monitored channel or data path when there is no voice activity on the monitored data path during an active call. In one implementation, the VAD only transmits a binary voicing decision output signal when the output changes value, i.e., when voice activity is no longer detected after a period of voice activity or when voice activity is once again detected after a period of silence. In another implementation, the VAD transmits a binary voicing decision output signal periodically.

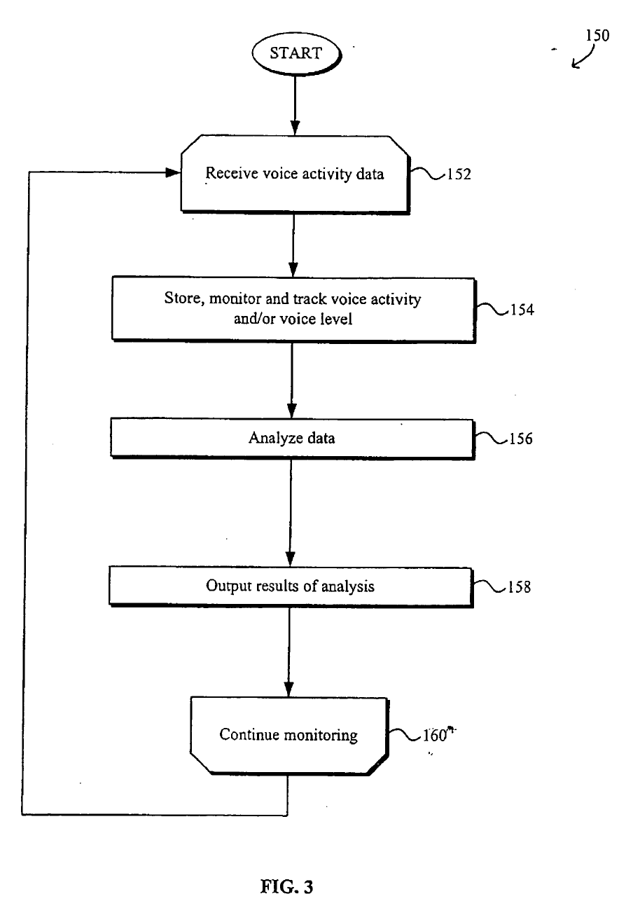

FIG. 3 is a flowchart illustrating a voice activity analysis process 150 performed by the voice activity processing system 120. In particular, at step 152, the voice activity processing system receives voice activity data. In particular, the voice activity processing system receives voicing decision output signals from the VAD on transmit and/or the VAD on receive are received. The voice activity processing system may additionally receive data on the voice activity level (amplitude). At step 154, the voice activity and optionally the voice activity level data are stored, monitored and/or tracked. For example, the voice activity may be monitored and tracked for each call, each work shift, each operator, and/or each group of operators such as those in a particular call center, in a particular department, or under a particular supervisor. The voice activity may also be time stamped by the voice activity processing system so as to determine the anatomy of the conversation by tracking the progression of the conversation and identifying periods of silence, etc.

The voice activity data is then analyzed using various performance metrics at step 156. For example, in generating the performance metrics, the periods of talk, listen, doubletalk and/or silence as well as voice levels may be determined, tracked, and analyzed. For example, doubletalk is detected when voice signals on both the transmit and receive are detected, i.e., when both parties to the conversation are talking. The performance metrics may include analyzing and comparing the data to certain targets or measures such as maximum talk time during a shift to prevent voice strain, maximum talk time over a certain voice level during a shift to identify stress, and/or maximum doubletalk time during any conversation to detect possible arguments, confrontations and/or problems with transmission. The performance metrics may also include using doubletalk data to track the number of interruptions in the conversation and which party to the conversation is being interrupted. The performance metrics may also utilize the voice activity levels to help determine stress or strain in the agent's voice, whether the conversation is calm or excited, and/or whether a question or statement is being spoken. The performance metrics facilitate in better determining and tracking the performance quality and characteristics of each operator or group of operators at, for example, call centers and thus improve quality and productivity at the call centers. In particular, the voice activity processing system may help improve the quality and productivity by providing better performance quality metrics and by more accurately identifying areas in which a given operator may need improvement and/or additional training. Such analyses may result in improved effectiveness, reduced call times, increased customer satisfaction and/or protect the health of the operators, as will be described in more detail below.

The result of the analysis is output at step 158. The output may include displaying the output and/or transmitting the output for use by another system such as a predictive dialer system and/or an ACD system to help control the flow and assignment of calls to the agents. For example, the ACD and/or the predictive dialer system may utilize an agent stress performance metric to route fewer calls to an agent who appears stressed and/or to provide more frequent and/or longer breaks to the agent. The ACD system may also increase the rate at which calls are routed to an agent who appears to be efficient yet not stressed and is not in danger of suffering from voice strains. Various other performance metrics may also be generated and utilized. The process continues with further monitoring at step 160 by returning to step 152.

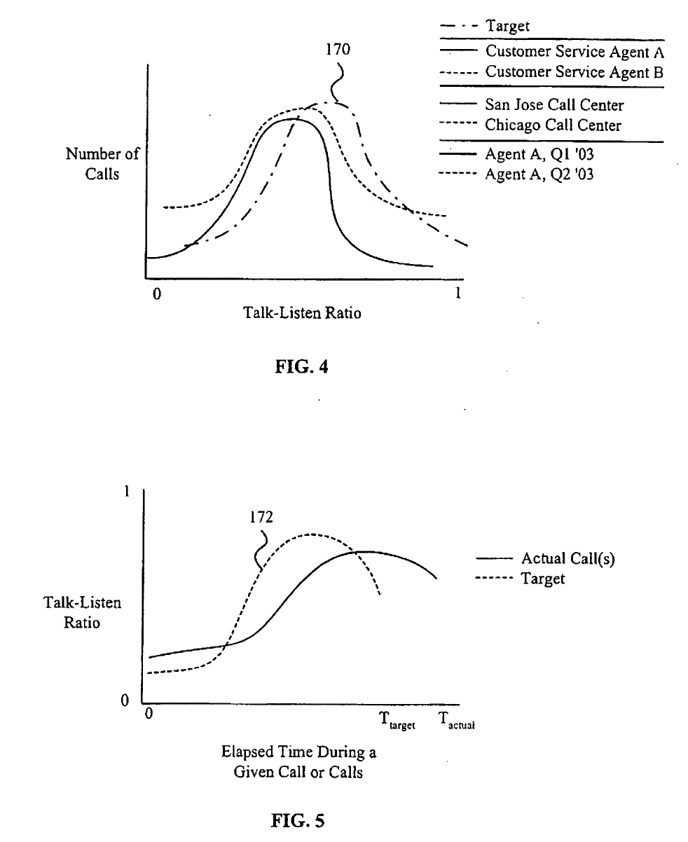

As noted above, the voice activity processing system may be configured to generate various performance metrics based on the data from the tracking and monitoring of voice activity on the transmit and/or receive data paths. FIGS. 4-7 illustrate some examples of such performance metrics. In particular, FIG. 4 is an example of a graph illustrating the ratio of time spent talking to time spent listening (also referred to herein as talk-listen ratio) for each call to the number of calls in a given period of time, i.e., a histogram. The talk-listen ratio to the number of calls may be determined for one operator or for a group of operators such as those at a particular call center or those who are still in training, for example. The period of time may be a day, a shift, a month, a quarter, and so forth.

A comparison of the talk-listen ratio to number of calls metric may be made amongst various agents, for the same agent over different periods of time such as for different parts of the shift or for different days, weeks, or successive quarters, for various call centers or departments, etc. A comparison may be additionally or alternatively made against a target or ideal talk-listen ratio to number of calls curve 170.

FIG. 5 is an example of a graph illustrating the talk-listen ratio over the duration of a given call or averaged for several calls. The talk-listen ratio may be determined as a running average over a short period of time relative to the average length of a call, e.g., 5 to 10 seconds. The talk-listen ratio over the duration of one or several calls may be determined for one operator or for a group of operators such as those at a particular call center or those who are still in training, for example. The calls may be taken from a period of time such as a day, a shift, a month, a quarter, and so forth.

A comparison of the talk-listen ratio over the duration of one or more calls may be made amongst various agents, for the same agent over different periods of time such as for different parts of the shift or for different days, weeks, or successive quarters, for various call centers or departments, etc. A comparison may be additionally or alternatively made against a target or ideal talk-listen ratio over the duration of the call curve 172.

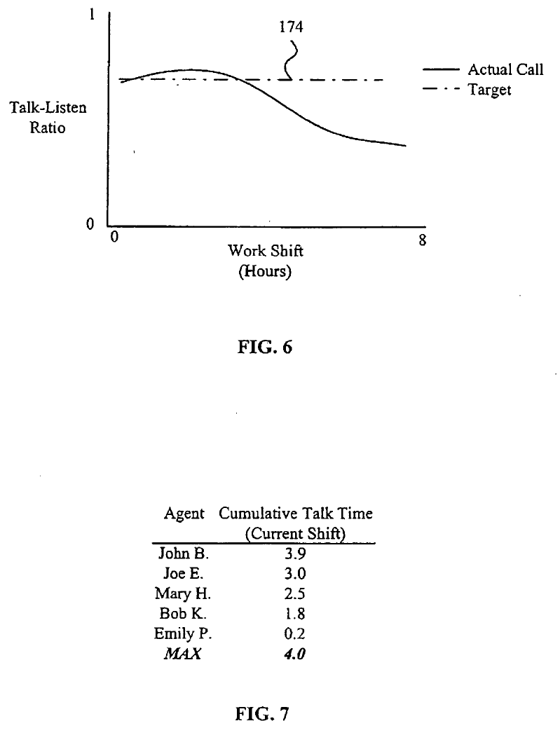

FIG. 6 is an example of a graph illustrating the average talk-listen ratio over time such as the duration of a work shift. The talk-listen ratio may be determined as a running average over a period of time, e.g., the average length of a call. The talk-listen ratio over the duration of a time period may be determined for one operator or for a group of operators such as those at a particular call center or those who are still in training, for example. The calls may be taken from a period of time such as a day, a shift, a month, a quarter, and so forth.

A comparison of the talk-listen ratio over the duration of a given time period may be made amongst various agents, for the same agent over different periods of time such as for different parts of the shift or for different days, weeks, or successive quarters, for various call centers or departments, etc. A comparison may be additionally or alternatively made against a target talk-listen ratio 174. The monitoring of the talk-listen ratio over time can help determine if fatigue is setting in over time, for example.

FIG. 7 is an example of a chart illustrating the cumulative talk time for each agent for the current shift. Such a metric may help identify operators who are at risk of straining their voices. For example, the maximum cumulative talk time for each agent in the current shift may be 4.0 hours. This metric may be utilized to identify operators who are at risk of straining their voices and to have them take a break. For example, once the operators with high cumulative talk times are identified, their talk-listen ratio metrics may be evaluated and/or compared to the target so as to determine whether improvement or additional training or supervision may be needed.

These are merely some examples of suitable performance metrics that may be generated from the monitoring and tracking of voice activity on the transmit and/or receive channels. The various performance metrics may be utilized to assess and improve the quality and effectiveness of the calls. For example, in a telemarketing application, the talk-listen ratio is preferably higher than for an operator in a counseling application, e.g., technical support, where the operator should spend some time listening. The talk-listen ratio trend during a given call may also be tracked to determine effectiveness and/or efficiency. For example, in a technical support application, the operator should start out mostly listening and then progress to mostly talking as the problem is identified and the solution is provided. These metrics can also help identify agents who may be in need of further training or supervision and/or agents who should be awarded for high quality and efficiency.

As is evident, the voice activity processing system and the voice activity analysis process can facilitate in improving operator productivity and effectiveness by providing quality performance metrics. By analyzing the particular application together with the performance metrics feedback, the operators can improve their effectiveness, reduce call times, improve customer satisfaction and even protect their health.

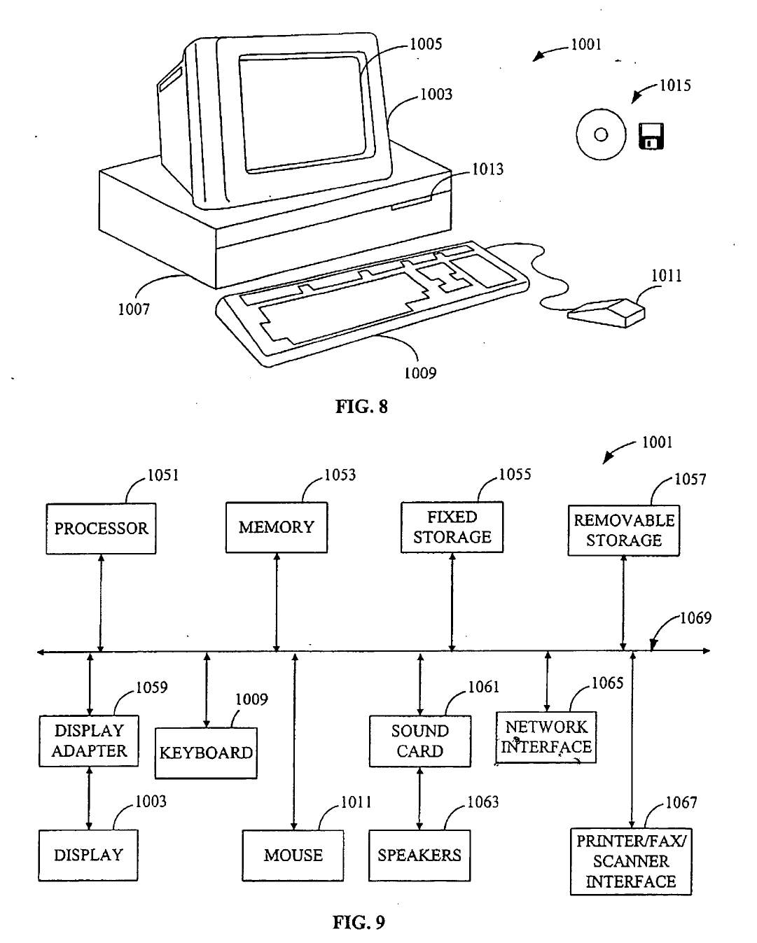

FIGS. 8 and 9 illustrate a schematic and a block diagram, respectively, of an exemplary general purpose computer system 1001 suitable for executing software programs that implement the methods and processes described herein. The architecture and configuration of the computer system 1001 shown and described herein are merely illustrative and other computer system architectures and configurations may also be utilized.

The exemplary computer system 1001 includes a display 1003, a screen 1005, a cabinet 1007, a keyboard 1009, and a mouse 1011. The cabinet 1007 typically houses one or more drives to read a computer readable storage medium 1015, a system memory 1053, and a hard drive 1055 which can be utilized to store and/or retrieve software programs incorporating computer codes that implement the methods and processes described herein and/or data for use with the software programs, for example. A CD and a floppy disk 1015 are shown as exemplary computer readable storage media readable by a corresponding floppy disk or CD-ROM or CD-RW drive 1013. Computer readable medium typically refers to any data storage device that can store data readable by a computer system. Examples of computer readable storage media include magnetic media such as hard disks, floppy disks, and magnetic tape, optical media such as CD-ROM disks, magneto-optical media such as floptical disks, and specially configured hardware devices such as application-specific integrated circuits (ASICs), programmable logic devices (PLDs), and ROM and RAM devices.

Further, computer readable storage medium may also encompass data signals embodied in a carrier wave such as the data signals embodied in a carrier wave carried in a network. Such a network may be an intranet within a corporate or other environment, the Internet, or any network of a plurality of coupled computers such that the computer readable code may be stored and executed in a distributed fashion.

The computer system 1001 comprises various subsystems such as a microprocessor 1051 (also referred to as a CPU or central processing unit), system memory 1053, fixed storage 1055 (such as a hard drive), removable storage 1057 (such as a CD-ROM drive), display adapter 1059, sound card 1061, transducers 1063 (such as speakers and microphones), network interface 1065, and/or printer/fax/scanner interface 1067. The computer system 1001 also includes a system bus 1069. However, the specific buses shown are merely illustrative of any interconnection scheme serving to link the various subsystems. For example, a local bus can be utilized to connect the central processor to the system memory and display adapter.

Methods and processes described herein may be executed solely upon CPU 1051 and/or may be performed across a network such as the Internet, intranet networks, or LANs (local area networks) in conjunction with a remote CPU that shares a portion of the processing.

While the preferred embodiments of the present invention are described and illustrated herein, it will be appreciated that they are merely illustrative and that modifications can be made to these embodiments without departing from the spirit and scope of the invention. Thus, the invention is intended to be defined only in terms of the following claims.

1. A computer readable storage medium storing instructions that when executed by a computer cause the computer to perform a method for generating a voice activity performance metric comprising the steps of:
detecting voice activity on at least one of a receive and a transmit channel in a communications system;
outputting voicing decision outputs based on the step of detecting;
storing the voicing decision outputs over a period of time to a computer readable memory; and
generating a voice activity performance metric comprising a duration of voice activity based on the voicing decision output stored in the computer readable memory.

2. The computer readable storage medium of claim 1, wherein the step of generating includes generating a running average ratio of duration of voice activity on the transmit channel to duration of voice activity on the receive channel over a predetermined period of time.

3. The computer readable storage medium of claim 2, wherein the predetermined period of time is selected from the group consisting of a duration of a telephone call over the communications system, a work shift, a work day, a week, a month, a year, and a predetermined number of days.

4. The computer readable storage medium of claim 1, wherein the step of generating includes generating an average ratio of duration of voice activity on the transmit channel to duration of voice activity on the receive channel for each communications system agent.

5. The computer readable storage medium of claim 1, wherein the performance metric facilitates detecting at least one of voice strain, stress, and excessive doubletalk.

6. The computer readable storage medium of claim 1, the method further comprising the step of comparing a ratio of duration of voice activity on the transmit channel to duration of voice activity on the receive channel to a target ratio.

7. The computer readable storage medium of claim 1, the method further comprising the step of outputting the voice activity performance metric to a display.

8. The computer readable storage medium of claim 1, wherein the step of detecting is performed throughout an active call via the communications system.

9. The computer readable storage medium of claim 1, wherein the step of detecting includes detecting voice activity on both the receive channel and the transmit channel in the communications system.

10. The computer readable storage medium of claim 1, wherein the step of detecting includes detecting voice activity on only the transmit channel in the communications system and wherein the step of generating includes generating ratios of duration of voice activity to duration of no voice activity on the transmit channel.

11. The computer readable storage medium of claim 1, the method further comprising the step of automatically routing calls based at least in part on the voice activity performance metric.

12. A system, comprising:
a voice activity detector (VAD) configured to detect voice activity on at least one of a receive and a transmit channel in a communications system;
a memory to store outputs from the VAD; and
a voice activity analyzer in communication with the memory, the voice activity analyzer being configured to generate a performance metric comprising a duration of voice activity based on the VAD outputs stored in the memory.

13. The system of claim 12, wherein the voice activity analyzer is further configured to generate a running average ratio of duration of voice activity on the transmit channel to duration of voice activity on the receive channel over a predetermined period of time.

14. The system of claim 13, wherein the predetermined period of time is selected from the group consisting of a duration of a telephone call over the communications system, a work shift, a work day, a week, a month, a year, and a predetermined number of days.

15. The system of claim 12, wherein the voice activity analyzer is further configured to generate an average ratio of duration of voice activity on the transmit channel to duration of voice activity on the receive channel for each communications system agent.

16. The system of claim 12, wherein the voice activity analyzer is further configured to compare a ratio of duration of voice activity on the transmit channel to duration of voice activity on the receive channel to a target ratio.

17. The system of claim 12, wherein the performance metric facilitates detecting at least one of voice strain, stress, and excessive doubletalk.

18. The system of claim 12, further comprising a display wherein the voice activity analyzer is further configured to output the voice activity performance metric to the display.

19. The system of claim 12, wherein the VAD is configured to detect voice activity throughout an active call via the communications system.

20. The system of claim 12, wherein the VAD is further configured to detect voice activity on both the receive channel and the transmit channel in the communications system.

21. The system of claim 12, wherein the VAD is further configured to detect voice activity on only the transmit channel in the communications system and wherein the voice activity analyzer is further configured to generate ratios of duration of voice activity to duration of no voice activity on the transmit channel.

22. The system of claim 12, further comprising an automatic call routing system in communication with the voice activity analyzer, the automatic call routing system being configured to automatically route calls based at least in part on the performance metric.
